(19) United States
(12) Patent Application Publication
(10) Pub. No.: US 2003/0084148 A1
(43) Pub. Date: May 1, 2003

(54) Methods and systems for passive information discovery using cross spectral density and coherence processing

(76) Inventors: David Bruce Cousins, Barrington, RI (US); Tushar Saxena, Lexington, MA (US)

Correspondence Address: Leonard C. Suchyta, c/o Christian Andersen, Verizon Services Group, 600 Hidden Ridge, HQE03H01, Irving, TX, 75038, US

(21) Appl. No.: 10/254,161

(22) Filed: Sep. 25, 2002

Related U.S. Application Data
(63) Continuation-in-part of application No. 10/112,001, filed on Oct. 19, 2001.
(60) Provisional application No. 60/339,288, filed on Oct. 26, 2001.
(60) Provisional application No. 60/340,780, filed on Oct. 30, 2001.
(60) Provisional application No. 60/355,573, filed on Feb. 5, 2002.

(51) Int. Cl. H04L 9/00; G06F 15/173

(52) U.S. Cl. 709/224; 713/160

(57) ABSTRACT

A method analyzing communication in a network [100, 200] may include obtaining time of arrival information for chunks of data in the network. A number of signals [410-460] may be constructed to represent the time of arrival information at respective nodes in the network. A pair of the number of signals may be processed to obtain similarity information [610-660, 710-760] about data flow between a corresponding pair of nodes. Data flow between the pair of nodes may be analyzed using the cross spectral density or coherence information.

### RELATED APPLICATION

This application claims the benefit of priority under 35 U.S.C. §119(e) of three provisional applications, serial Nos. 60/339,288, 60/340,780, and 60/355,573, filed Oct. 26, 2001, Oct. 30, 2001 and Feb. 5, 2002, respectively, the entire contents of which are incorporated herein by reference.

This application is also a continuation-in-part (CIP) under 37 C.F.R. §1.53(b) of application Ser. No. 10/112,001, filed Oct. 19, 2001, (attorney docket number 00-4056) the entire contents of which are incorporated herein by reference.

### GOVERNMENT INTEREST

The invention described herein was made with government support. The U.S. Government may have certain rights in the invention, as provided by the terms of contract No. MDA972-01-C-0080, awarded by the Defense Advanced Research Projects Agency (DARPA).

### BACKGROUND OF THE INVENTION

1. Field of the Invention

The present invention relates generally to communication networks, and more specifically, to the monitoring of data transmitted over such networks.

2. Description of Related Art

Communication networks typically include a number of interconnected communication devices. Connections among the devices in some communication networks are accomplished through physical wires or optical links. Such networks may be referred to as “wired” networks. Connections among the devices in other communication networks are accomplished through radio, infrared, or other wireless links. Such networks may be referred to as “wireless” networks.

Communication messages (e.g., data packets) sent across communication networks may be intercepted. Intercepted messages may yield valuable information, and the process of intercepting and analyzing messages may be referred to as “traffic analysis.” In general, traffic analysis seeks to understand something about the message traffic by passively observing the traffic and analyzing that traffic to extract information. To guard against unwanted traffic analysis, messages are typically encrypted. For example, both the content and the destination of a message could be obscured through encryption.

In some situations, however, it may still be desirable to monitor traffic flow over communication networks. Accordingly, there is a need to monitor traffic flow even when identifying information associated with the messages is encrypted.

### SUMMARY OF THE INVENTION

Methods and systems consistent with the present invention address this and other needs by coherence information associated with arrival times of chunks of data at pairs of nodes to determine data flow between the pairs of nodes.

In accordance with one purpose of the invention as embodied and broadly described herein, a method analyzing communication in a network may include obtaining time of arrival information for chunks of data in the network. A number of signals may be constructed to represent the time of arrival information at respective nodes in the network. A pair of the number of signals may be processed to obtain similarity information about data flow between a corresponding pair of nodes.

In another implementation consistent with the present invention, a method of processing communication signals may include associating the signals into pairs of the signals and computing a number of coherence data from different pairs of the signals. The number of coherence data may be combined in time sequence to form a number of coherograms containing the coherence data. The number of coherograms may be analyzed to derive information about data flow.

In a further implementation consistent with the present invention, a method of processing a number of communication signals obtained from a respective number of different nodes in a network may include computing a number of coherence data from different pairs of the signals. A number of coherence band values may be generated for at least two frequency bands within the coherence data. The number of coherence band values may be combined in time sequence to form a number of coherence band level data.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram illustrating an exemplary wired network and tap according to an implementation consistent with the present invention;

FIG. 2 is a diagram illustrating an exemplary wireless network and tap according to an implementation consistent with the present invention;

FIG. 3 is an exemplary diagram of traffic flow analysis and classification processing in the networks of FIGS. 1 and 2;

FIGS. 4A and 4B are exemplary signals that may be generated from tracefiles according to an implementation consistent with the present invention;

FIG. 5 illustrates a simulated wireless network with which coherence experiments were performed;

FIG. 6 shows several coherence plots generated from signals obtained from the simulated network of FIG. 5;

FIG. 7 shows several coherograms generated from signals obtained from the simulated network of FIG. 5;

FIG. 8 shows a number of coherence band level plots generated from signals obtained from the simulated network of FIG. 5; and

FIG. 9 is an exemplary routing diagram generated using the coherence band level plots from FIG. 8.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Data encryption may hide the contents of packets (i.e., discrete units of data), but it does not obscure basic protocol mechanisms and dynamics. Some examples of these basic mechanisms may include the packet's source, destination, and the interpacket gaps caused by certain applications.

Methods and systems consistent with the principles of the invention use coherence information of intercepted communication data to determine traffic flow among nodes, even when the data is encrypted. Coherence information between different pairs of nodes may be used to determine routing and routing changes within the network.

### Exemplary Wired Network

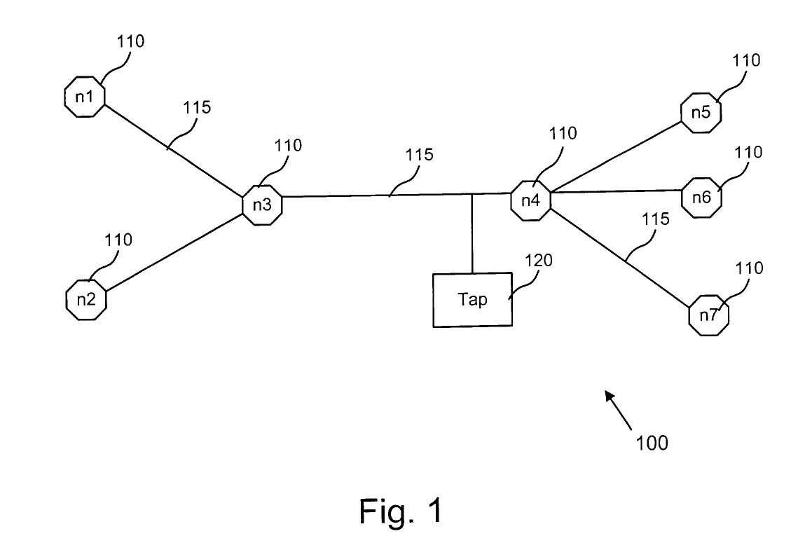

FIG. 1 is a diagram illustrating an exemplary wired network 100 according to an implementation consistent with the present invention. The wired network 100 may include a number of network nodes 110 connected by a number of network links 115. The wired network 100 may also include one or more network taps 120. Although seven nodes 110 and one tap 120 are shown connected in a particular configuration, this is purely exemplary. Wired network 100 may include any number and configuration of nodes 110, links 115, and taps 120.

Network nodes 110 may be configured to send and receive information according to a communication protocol, such as TCP/IP. Although not specifically shown, some nodes 110 may be configured to provide a route for information to a specified destination. Other nodes 110 may be configured to send the information according to a previously-determined route. The network nodes 110 may communicate via discrete “chunks” of data that are transmitted by “senders” 110. A chunk may be individually detectable or distinguishable (i.e., a listening device, such as tap 120, may determine when a chunk starts and ends). A chunk of data need not exactly correspond to a packet of data. A chunk may represent part of a packet (e.g., a fragment or an ATM cell of an AAL5 PDU), or multiple packets (e.g., two packets concatenated).

Chunks of data may be transmitted by “senders” 110. A sender 110 may be the most recent node 110 to transmit a particular chunk (e.g., node n3 in FIG. 1, if the tap 120 intercepts a chunk transmitted to node n4). The sender 110 is not necessarily the node 110 that originated the chunk.

Network links 115 may include electronic links (e.g., wires or coaxial cables) and optical links (e.g., fiber optic cables). These links 115 may provide a connection between two nodes 110 (e.g., nodes n1 and n3). It may be possible to physically tap into these links 115 to observe the information carried on them.

Network tap 120 is a device that may intercept chunk transmissions on the network 100. The tap 120 may include a physical connection to a corresponding link 115 and circuitry to detect chunks of data on the link 115. The tap 120 may intercept chunks at a physical layer, a link layer, a network layer, or at higher layers of the network 100 being monitored. The layer at which interceptions occur is within the abilities of those skilled in the art, and may be chosen based on knowledge of, and access to, the network links 115. The tap 120 may include, for example, a transceiver for sensing the chunks of data and may also include other circuitry (e.g., clock circuitry) for determining times of arrival and duration of the chunks. The tap 120 may include a processor for computing any other information associated with the chunks, such as information (e.g., sending node and/or receiving node) contained within a header of the chunk of data.

Tap 120 may observe traffic on the link 115 between nodes n3 and n4. Tap 120 may record information about all the chunks that it observes in a “tracefile.” The tracefile may contain a minimum amount of information for each observed chunk. For example, the information may include the time the chunk was seen and the identity of the sender 110 of the chunk. The identity of the sender 110 may include, for example, the IP address of an IPsec gateway, the upstream or downstream transmitter on the point-to-point link 115, or “the same sender 110 as the one that also sent these other chunks.” If available, the tracefile may also include additional information about the length or duration of the chunk, the observed direction of flow, the destination node 110, or any insight into the contents of the chunk. Other information that may be available is the location of the tap 120 along the link 115 relative to the nodes 110 at either end of the link 115.

Tap 120 may not capture all traffic on the link 115. For example, tap 120 may occasionally make an error and mistakenly believe it has seen a chunk when no chunk was sent (e.g., due to bit errors on wired network 100). If transmissions are missed, false transmissions are detected, or if a sender 110 is misclassified, these events may be viewed as adding noise to the signals generated by the tap 120. Other sources of noise in the signal generated by the tap 120 may include interference from other signals (e.g., packets belonging to another flow, or jitter in timing due to sharing of a bottleneck among multiple flows).

Tap 120 may listen passively and may not participate in the monitored network 100 at the MAC (or higher) layers. In some cases, for example with 802.3 LANs, it is possible for the tap 120 to snoop at the MAC layer and extract some information about higher layer protocols. In the case of SONET networks, however, little or no information may be available about the MAC or higher layer protocols.

Although a single tap 120 is shown in FIG. 1, wired network 100 may contain many taps 120, which may be interconnected. Taps 120 may work independently using purely local information. Distributed algorithms may allow sharing of information among taps 120. In such a case, taps 120 may have a globally synchronized clock that allows information from multiple taps 120 to be combined. A clock resolution of the taps 120 may be finer than the data sampling resolution of the taps 120, so that information about transmissions (e.g., the start time, duration, inter-transmission gap, and even the presence of short transmissions) is not missed.

A tap 120 (or a network of taps 120) should store the transmissions that it detects for a sufficient amount of time. For example, the round-trip time of a transport layer flow cannot be determined if the history that may be stored at tap 120 is less than one roundtrip time. The total volume of data that must be stored depends on the capacity of the link 115 and the maximum round-trip time of flows seen on the link 115. Taps 120 may assign a unique identifier to each sender 110, for example, based on the address of the IPsec gateway. Taps 120 in the network 100 may assign the same unique identifier to any given sender 110.

### Exemplary Wireless Network

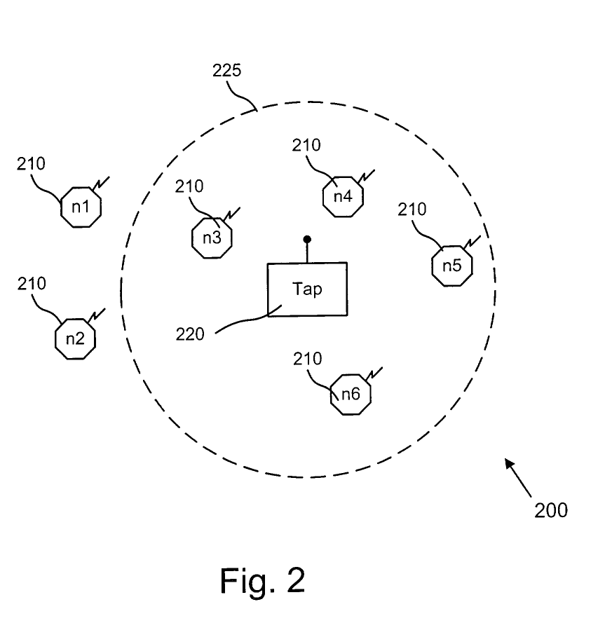

FIG. 2 is a diagram illustrating an exemplary wireless network 200 according to an implementation consistent with the present invention. The wireless network 200 may include a number of wireless nodes 210 and one or more wireless taps 220. The wireless nodes 210 may communicate via wireless transmission, either point-to-point or, more typically, broadcast transmission. The wireless tap 220 may have an associated area 225 in which it may be able to intercept wireless transmissions.

Although six nodes 210 and one tap 220 are shown in FIG. 2, this is purely exemplary. Wireless network 200 may include any number and configuration of nodes 210 and taps 220. The behavior and operation of the wireless nodes 210 and the wireless tap 220, where similar to the network nodes 110 and tap 120 described above, will not be repeated.

Wireless nodes 210 may communicate via chunks of data that are transmitted by senders 210. Senders 210 may transmit using various types of wireless physical layers, such as terrestrial RF, satellite bands, and free space optical. Nodes n1-n6 may be, for example, radio routers or client radios in the wireless network 200.

Wireless tap 220 is a device that may intercept wireless transmissions on the network 200. Unlike tap 120, which may detect chunks of data only on a certain link 115, wireless tap 220 may observe some (potentially very large) fraction of the wireless spectrum, and thus may see transmissions from a wide range of senders 220. As shown in FIG. 2, tap 220 may have a limited effective reception range. Dashed line 225 indicates an effective reception area through which tap 220 may receive communications from the nodes. As shown, nodes n1 and n2 are out of the effective reception area and will not be monitored by tap 220. Nodes n3-n6, which are within the range 225, may be monitored by tap 220. The tap 220 may include, for example, a transceiver for sensing the chunks of data and may also include other circuitry (e.g., clock circuitry) for determining times of arrival and duration of the chunks. The tap 220 may include a processor for computing any other information (e.g., the sending or receiving node) associated with the chunks, such as information contained within physical characteristics of the chunk of data.

Wireless tap 220 also may record information about all the chunks that it observes in a tracefile. The tracefile may contain a minimum amount of information for each observed chunk. For example, the information may include the time the chunk was seen and the identity of the sender 210 of the chunk. The identity of the sender 210 may include, for example, an RF signature, the location of a radio transmitter 210, or “the same sender 210 as the one that also sent these other chunks.” If available, the tracefile may also include additional information about the length or duration of the chunk, the destination node 210, or any insight into the contents of the chunk. Other information that may be available is the geographic location of the tap 220, as determined by, for example, a global positioning system (GPS) receiver.

Tap 220 may not capture all traffic within its range 225. For example, reception on the wireless network 200 may be variable due to environment, noise, transmission power, or jamming such that a tap is unable to observe some transmissions. Furthermore, tap 220 may occasionally make an error and mistakenly believe it has seen a chunk when no chunk was sent (again due to noise on a wireless network). If transmissions are missed, false transmissions are detected, or if a sender 210 is misclassified, these events may be viewed as adding noise to the signals generated by the tap 220. Other sources of noise in the signal generated by the tap 220 may include interference from other signals (e.g., packets belonging to another flow, or jitter in timing due to sharing of a bottleneck among multiple flows).

Tap 220 may listen passively and may not participate in the monitored network 200 at the MAC (or higher) layers. In some cases, for example with 802.11b LANs, it is possible for the tap 220 to snoop at the MAC layer and extract some information about higher layer protocols. In the case of tactical ad hoc networks, however, little or no information may be available about the MAC or higher layer protocols.

Although a single tap 220 is shown in FIG. 2, wireless network 200 may contain many taps 220, which may be interconnected. In general, the number of taps 220 placed in network 200 is determined by the desired coverage level of network 200. Taps 220 may work independently using purely local information. Distributed algorithms may allow sharing of information among taps 220. In such a case, taps 220 may have a globally synchronized clock that allows information from multiple taps 220 to be combined. A clock resolution of the taps 220 may be finer than the data sampling resolution of the taps 220, so that information about transmissions (e.g., the start time, duration, inter-transmission gap, and even the presence of short transmissions) is not missed.

In the presence of mobile nodes 210 (for example, in ad hoc wireless networks or Mobile IP), taps 220 may, but need not, be mobile. Taps 220 may be placed randomly over a specified geographic area, or in a pattern. Alternately, taps 220 may be placed near respective senders 210. Senders 210 can move into or out of range of one or more taps 220. Senders 210 typically may dwell in the range of one or more taps 220 long enough for transmissions to be observed, and the sources identified and recorded. Taps 220 may assign a unique identifier to each sender 210, for example, based on their RF signature. Taps 220 in the network 200 may assign the same unique identifier to any given sender 210.

### Exemplary System-Level Processing

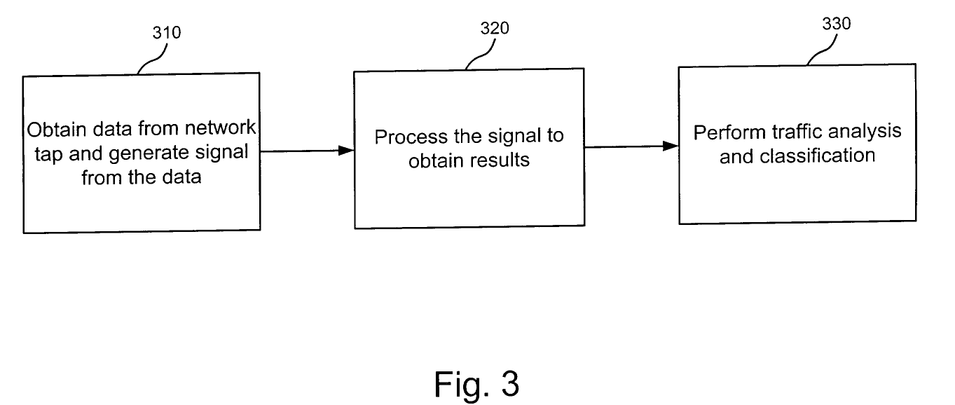

FIG. 3 is an exemplary diagram of traffic flow analysis and classification processing in networks 100 and 200. Processing may begin with a tap 120/220 obtaining data from its respective network 100/200. The tap 120/220 may also generate a signal from the data that it obtains [act 310].

Either the tap 120/220 or an associated (possibly central) processor (not shown) may perform processing on the signal produced by the tap 120/220 to produce results [act 320]. Such signal processing may produce identifiable signal traffic features, and may be computationally intensive. Those skilled in the art will appreciate, based on processing and networking requirements, whether to perform the signal processing at each tap 120/220 or other location(s).

The signal processing results may be further processed to analyze and classify the traffic on the network 100/200 [act 330]. Again, such traffic analysis processing may be performed by the tap 120/220 or another processor. Acts 310-330 may be broadly characterized as “signal generation,” “signal processing,” and “traffic analysis,” respectively. These acts will be described in greater detail for certain implementations below.

### Exemplary Signal Generation

Once a tap 120/220 has generated a tracefile of tapped data, a signal may be generated (e.g., as in act 310) from the tracefile for further traffic analysis. A tracefile may represent discrete events, namely a sequence of events associated with different times. The tracefile may include other information (e.g., sender or recipient information) associated with the events.

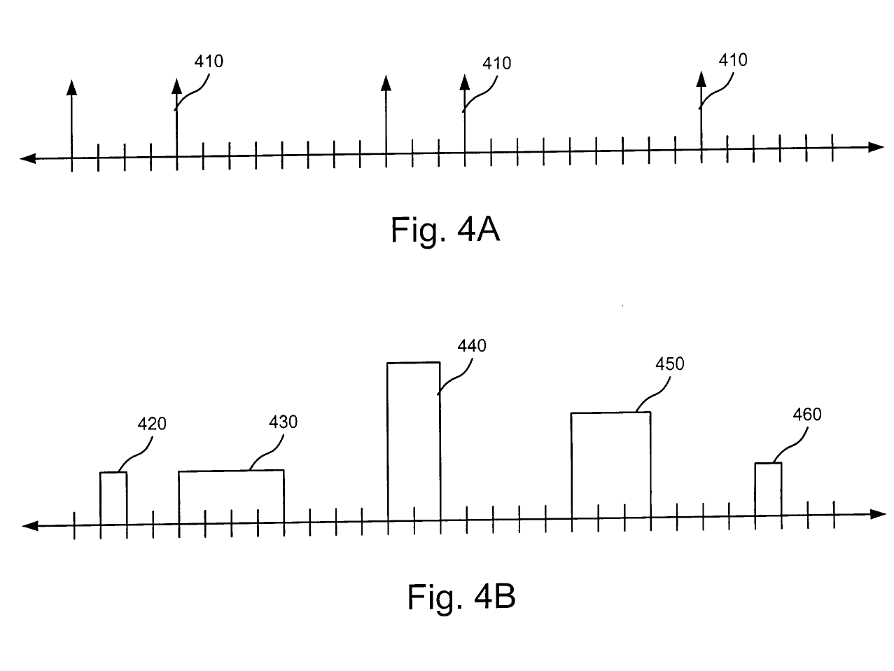

A general approach to producing a signal representing time of arrival of chunks is to pick an appropriate time quantization, to bin time into increments at that quantization, and to place a marker in the bins where a chunk was detected. At least three schemes may be used to represent the time of arrival of a chunk: 1) non-uniform time sampling, 2) uniform impulse sampling (e.g., FIG. 4A), and 3) uniform pulse sampling (e.g., FIG. 4B).

Under the first of the three schemes, a non-uniform signal may be represented as a non-uniformly-spaced sequence of impulses. Each impulse may indicate the leading edge of the discrete events in the tap's tracefile, where time is quantized to the desired resolution. Only a limited number of signal processing algorithms, however, have been derived for non-uniform sampled data. One example of such a signal processing algorithm is a Lomb Periodogram, which can process non-uniformly sampled data sets.

FIG. 4A illustrates the second scheme, which represents tracefile data as a uniformly sampled series of impulses 410. Such uniform sampling of the data implies a sample time quantization period (shown as tick marks in FIG. 4A). It is known that for accurate signal reconstruction, the data should be sampled such that the sampling frequency is greater than twice the highest frequency content of the data (i.e., the Nyquist rate). The tracefiles, however, contain discrete events (e.g., a chunk was seen at a particular time). So for most forms of processing, the discrete events of the tracefile are quantized into a time sequence of either impulses (e.g., FIG. 4A) or pulses (e.g., FIG. 4B) such that two closely spaced event can be resolved to different sample points.

Data may be encoded in each time increment as if it is a binary encoding: 1 (i.e., impulse 410) if a chunk is detected and 0 if not. More complex information, however, may be encoded in a time increment if such additional information is present in the tracefile. For example, if the duration of each chunk is known, then all the time increments during which a chunk was present may be set to 1, with 0's only during times when no chunks were visible. Such duration encoding would result in, for example, trains of adjacent impulses 410 (not shown).

Further, multiple chunks may be in transit at the same time. One approach to keep simultaneous data from being obscured may be to jitter the time of the conflicting events into empty adjacent sample times. Another approach to this issue may be to generate distinct tracefiles for each sender. Multiple tracefiles may refine later traffic flow analysis, by focusing on traffic from each sender separately. In another approach, rather than creating different encodings for different sources, the presence of multiple chunks may be encoded by placing a count of the number of live chunks in each increment. So there may be 3 chunks in one increment, 5 in the next, and so forth, where the number of chunks is encoded as the strength of the impulse 410.

FIG. 4B illustrates the third scheme, which represents tracefile data as a uniformly sampled series of pulses 420-460. If information about the duration of chunks is not present in the tracefile (or will not be encoded), the arrival of chunks may be encoded by a pulse of unit height and length (e.g., pulses 420 and 460). If the duration of each chunk is available, the time increments during which a chunk was present may be set to 1, with 0's only during times when no chunks were visible (e.g., pulses 430-450 and the spaces among them).

Similarly, if multiple chunks are in transit at the same time, the associated signal may be encoded as a series of weighted pulses whose pulse height encodes the number of chunks present at that time (e.g., pulses 440 and 450). Thus, pulses 420-460 may encode three pieces of information present in the tracefile: the start time of a chunk, the duration of the chunk, and how many chunks are present at a particular time.

Further, the pulses 420-460 need not be rectangular as shown in FIG. 4B. Pulses may be, for example, Gaussian pulses whose width and/or height may be proportional to as many as two different pieces of information.

Other encoding schemes will be apparent to those skilled in the art, depending on the amount of available information in the tracefiles and the ability of later signal processing schemes to use the available information. Exemplary schemes may include binary, single value encoding (e.g., amplitude proportional to value), multiple value encoding, pulse length encoding, and complex amplitude encoding, or combinations thereof. The above methods of generating signals from data collected by taps 120/220 are exemplary, and should not limit other methods of generating signals which may be implemented by those skilled in the art without undue experimentation.

### Exemplary Coherence Signal Processing

Given an encoded signal (e.g., that shown in FIGS. 4A or 4B), signal processing algorithms may be used to extract traffic information (e.g., as in act 320). Signal processing may reveal valuable information about the network 100/200 from traces containing minimum information (e.g., the times of arrivals of the chunks). Because such an approach does not require any information about the actual contents of the chunks themselves, such signal processing can work even with encrypted data transfers. An approach is to examine multiple encoded trace signals (e.g., FIGS. 4A or 4B) and identify the prominent frequencies between those signals.

Signals from multiple trace files may be analyzed in order to relate transmissions in one location with those at another. If there is enough periodicity in a trace file to show spectral or cepstral peaks, and if the transmissions of one source are answered back by another source at some layer of the network (such as with ACKs in TCP or via the MAC protocols in a wireless network), the degree that the two different signals are related may be computed.

Links between two nodes may be discovered by using a classical signal processing technique called coherence, which can reveal relationships (i.e., similarities) between two signals. The coherence between signals from the nodes may also reveal other important information about the flow between those nodes, such as the type of traffic and/or the application generating the traffic. Analysis of coherence over time may also allow analysis of networks (e.g., ad hoc wireless networks) in which the nodes move.

The Cross Spectral Density (CSD) is essentially the cross spectrum (i.e., the spectrum of the cross correlation) P_{xy}(k) of two (possibly random) sequences. The formula for the CSD is

$${P}_{xy} ( k ) = \frac{1}{KU} {\sum }_{r = 0}^{K - 1} {[ {X}_{N}^{( r )} ( k ) ] [ {Y}_{N}^{( r )} ( k ) ]}^{*}$$

Where

X_{N}^{(r)}(k)=DFT[w(n)xᵣ(n)]

$$U = \frac{1}{N} {\sum }_{n = 0}^{N - 1} {w}^{2} ( n )$$

and where [ ]* denotes the complex conjugate; xᵣ(n) is the r^{th} windowed segment of x(n); w(n) is a windowing function; K is the number of separate spectra; and U is the normalized window power. The resulting CSD shows how much the two spectra X(k) and Y(k) have in common. If two signals are randomly varying together with components at similar frequencies, and if they stay in phase for a statistically significant amount of time, their CSD P_{xy}(k) will show peaks at the appropriate frequencies. Two independent signals, by contrast, do not generate peaks. CSD may be complex valued, so the magnitude of the CSD is generally used in the same way the magnitude of the power spectral density (PSD) is used.

A version of the CSD, known as coherence, may be computed whose value is mapped between 0 and 1. The formula for the coherence is

$${C}_{xy} ( k ) = \frac{{\vert {P}_{xy} ( k ) \vert}^{2}}{{P}_{xx} ( k ) {P}_{yy} ( k )}$$

This coherence formulation is useful in situations where the typical dynamic range of spectra might cause scaling problems, such as in automated detection processing. Because the coherence is nicely bounded between 0 and 1, it enables easier automation using, for example, detection algorithms suited for this range of values. Because the absolute levels of P_{xy}(k), Pₓₓ(k), and P_{yy}(k), are lost, however, in one implementation coherence may be used in conjunction with the CSD, as opposed to a replacement. In another implementation, coherence may be used in the absence of the CSD. CSD and/or coherence may also be presented in “gram” form, where a number of coherence plots collected over time (i.e., the x-axis) are plotted along the y-axis. Such an aggregate arrangement of coherence plots over a length of time may be referred to as a “coherogram.”

CSD and coherence allow determination of what the power of the conversation between any two sources in the network was during a certain time-slice. Further, if transmission durations are encoded in the amplitude of the signal generated by the taps, then the power of the coherence peaks may provide a measure of the bandwidth of the communications between the nodes. As illustrated below this CSD/coherence technique may be useful for discovering routing topology in wireless networks, for example. Although the examples below use wireless networks, the CSD/coherence technique may also be applied to analyze traffic in wired networks.

### Exemplary Simulation Results

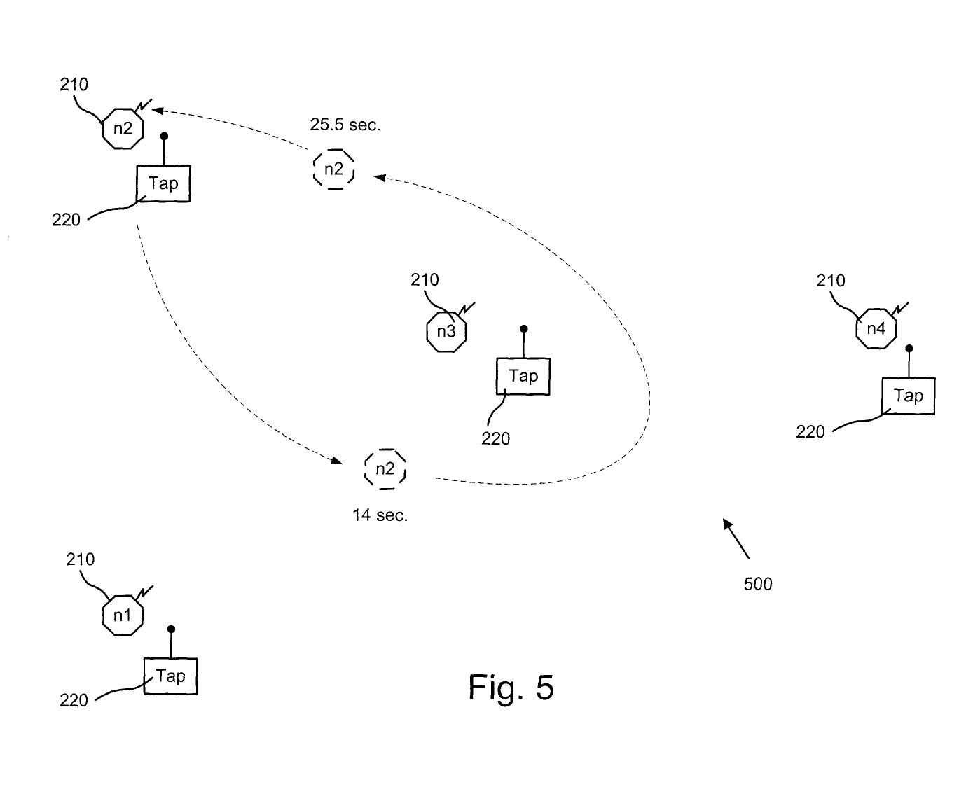

FIG. 5 illustrates a simulated wireless network 500 in which the processing described in FIG. 3 was performed on a signal generated from the simulated network. The simulated wired network 500 included four nodes 210 (i.e., n1-n4). Two data flows were present in the simulated network 500. The first data flow was an FTP (file transfer protocol) flow from node n1 to node n4 by way of node n3. The round trip time (including return of acknowledgments from node n4) for the FTP flow averaged 312 ms. The second data flow was a CBR (constant bit rate) flow from node n2 to node n4, also by way of node n3. The CBR flow sent 512 bytes/packet every 0.1 ms, and without acknowledgments from node n4.

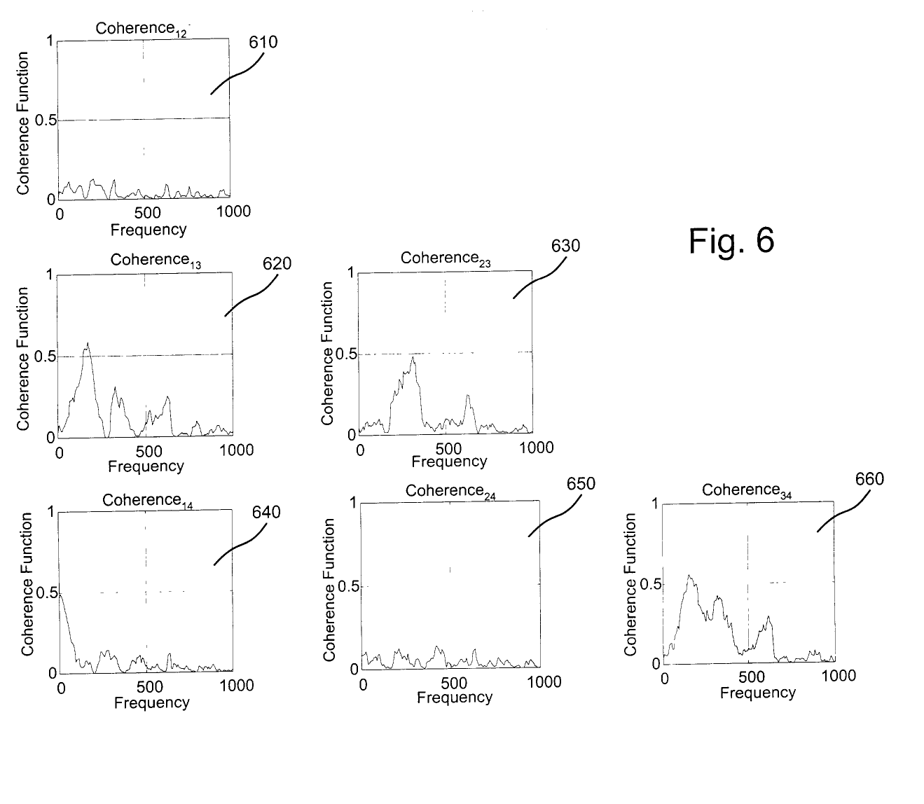

First the Coherence technique for detecting data flow will be demonstrated without the added complication of mobility. FIG. 6 shows the results of analyzing 30 seconds of trace data for coherence between different pairs of nodes n1-n4. FIG. 6 shows one coherence plot 610-660 for each different pair of nodes. For example, plot 610 illustrates Coherence₁₂, the coherence between signals at nodes n1 and n2. Plots with visible peaks indicate stronger coherence, which suggests two-way transactions (e.g., a conversation). Furthermore, the shape and frequency location of the peaks may also provide information which may allow differentiation among the types of data transfers (FTP vs. CBR, etc.).

It may be observed from FIG. 6 that strong peaks occur in plots 620-640 and 660 (i.e., between node pairs n1/n3, n2/n3, n1/n4, and n3/n4, respectively). The links between nodes n1/n2 and n3/n4 are carrying the FTP, and links between nodes n2/n3 and n3/n4 are carrying the CBR. The peaks in plot 640 (i.e., Coherence₁₄) are not due to a direct link between nodes n1 and n4. Rather, the peaks in plot 640 are due to the FTP transfer between nodes n1 and n4 causing those nodes to interact in a strongly periodic pattern due to the ACK feedback of TCP. There is a lack of coherence between nodes n1 and n2 because they do not share any information.

The strong coherence in plots 620, 630, and 660 may be used to detect the presence of data flows between the node pairs corresponding to these plots. This process may be used to determine the topology of a wireless network, for example, by inferring location of nodes by which pairs of nodes are communicating. To the extent that the shape of the coherence plots may be associated with a particular type of signal flow (i.e., plot 620 results from an FTP session, while plot 630 results from a CBR session), these coherence plots may also be used to determine the type of data flow between two nodes. Such flow type determination may be made based on the overall shape of the plot (i.e., all frequencies), or by looking at certain frequencies that are characteristic of a particular flow type (e.g., FTP), as will be appreciated by those skilled in the art.

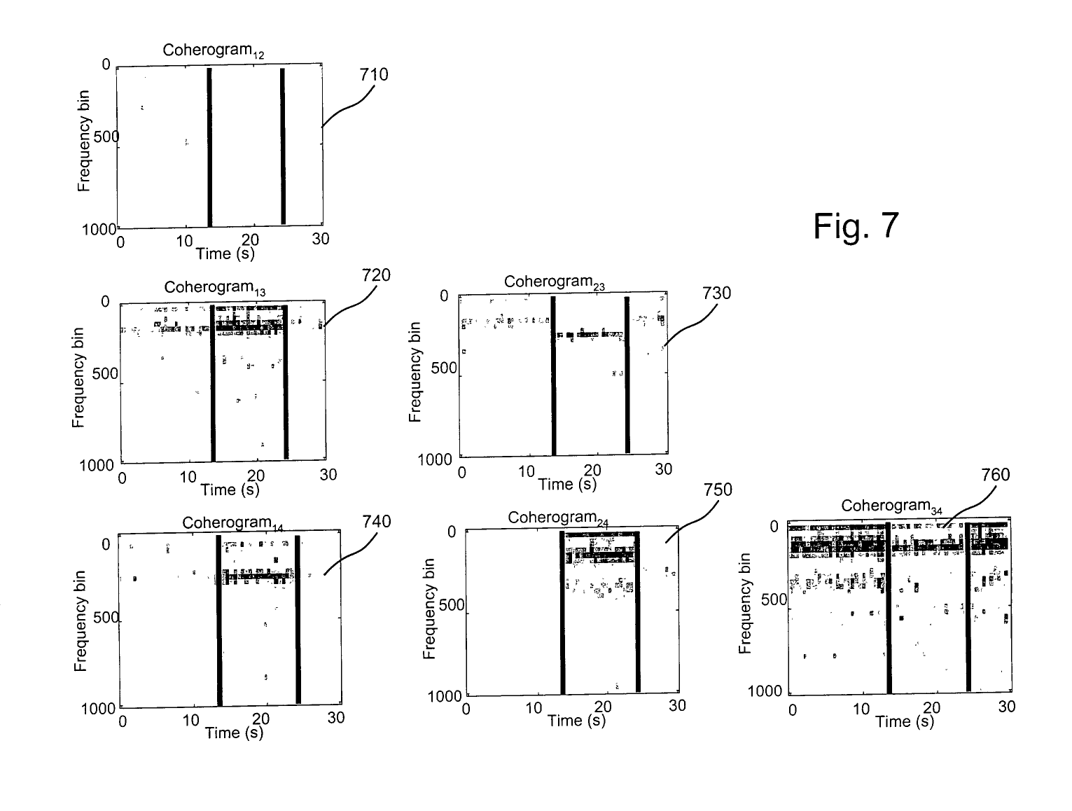

Next, the Coherence technique for detecting data flow will be demonstrated to track topology and routing changes in the mobile network 500. FIG. 7 shows a number of coherograms generated by analyzing 30 seconds of trace data taken from the wireless network 500. In this simulation, however, node n1 moves around node n3, as illustrated by the dotted lines in FIG. 5. This motion of node n2 causes rerouting of the wireless data to occur twice, first at 14 seconds into the run (i.e., the first dotted location in FIG. 5), and again at 25.5 seconds (i.e., the second dotted location in FIG. 5). Initially, traffic from node n1 is routed through node n3, until 14 seconds, when node n1 becomes close enough to node n4 to route directly. This continues until 25.5 seconds, when node n1 has circled far enough away from node n4 to resume routing through node n3.

Coherence spectra were computed for each 512 ms interval and displayed as a two-dimensional time-frequency coherogram where intensity is proportional to power at that time and frequency (i.e., white=low level to black=high level). The result is a coherogram plot 710-760 for each different pair of nodes (arranged similar to FIG. 6). When the coherence remains similar from one 512 ms time interval to the next, peaks in the coherence plots (e.g., 610-660) appear as horizontal lines in the plots 710-770. However, when the network reroutes at 14 seconds (i.e., the left vertical line in plots 710-760) and node n1 begins to communicate directly with node n4, the coherence peaks change visibly in plots 730 and 750 (i.e., Coherogram₂₃ and Coherogram₂₄). At 25.5 seconds (i.e., the right vertical line in plots 710-760), the coherence peaks again change visibly, and remain so until the network 500 resumes its original configuration. Such changes may be detected by automated schemes, such as that outlined below.

### Exemplary Flow Analysis Processing

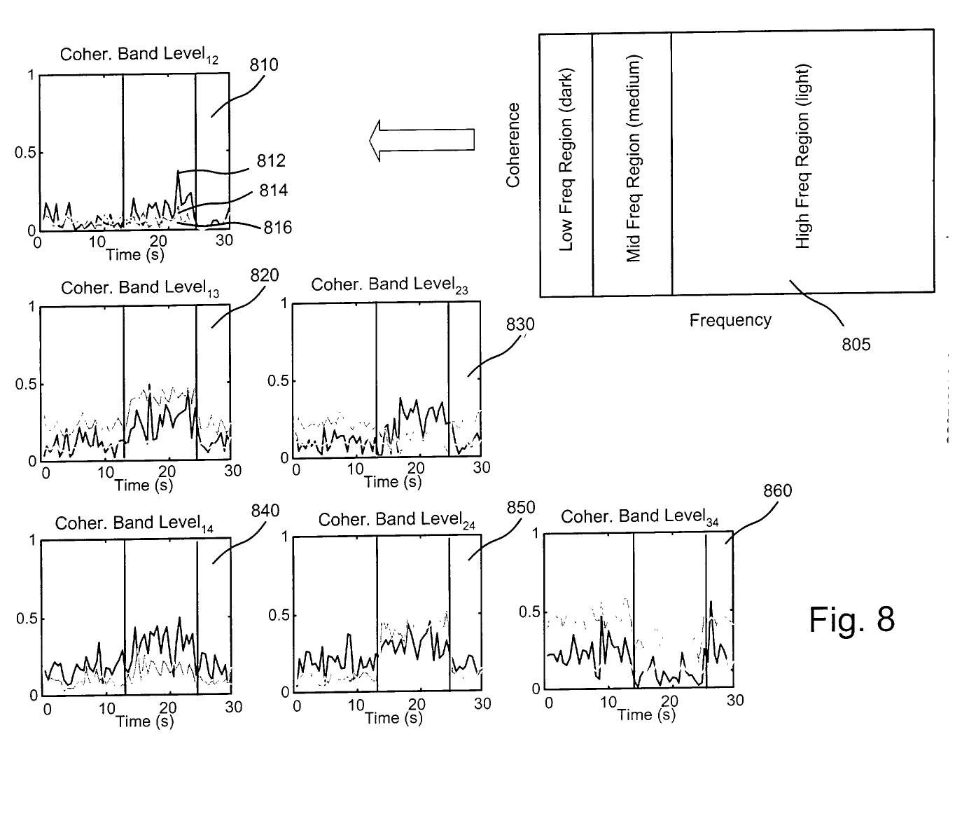

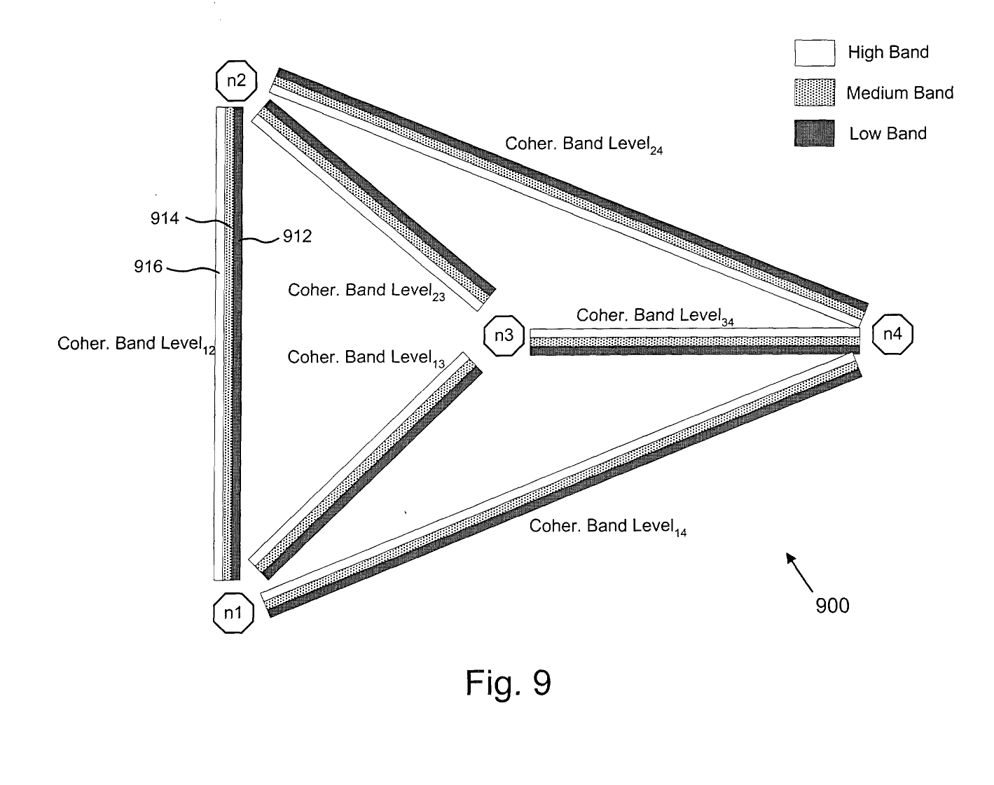

Various signal analysis techniques will be apparent to those skilled in the art to analyze data flows among the nodes 210 in the network 500 (or any other network for which tapped signals are available) based on, for example, the data in FIGS. 6 and 7. One such exemplary processing scheme for visualizing and detecting data flow will be described with respect to FIGS. 8 and 9.

FIG. 8 shows a number of coherence band level plots generated from signals obtained from the simulated network 500. Plot 805 illustrates conceptually how a coherence plot (e.g., 610-660) may be “banded” (i.e., segmented by frequency) into two or more frequency bands of interest. In FIG. 8, plot 805 is separated into a low frequency region, a middle frequency region, and a high frequency region. Coherence data within these frequency regions may be summed and normalized by the bandwidth of the frequency region to generate a single coherence band level for each frequency band. With reference to Coherence Band Level₁₂ (810), coherence band levels 812 (dark), 814 (medium), and 816 (light) correspond to the low, middle, and high frequency bands, respectively, in plot 805.

If coherence data is available over time (e.g., FIG. 7), the coherence band levels may be computed for each timer interval (e.g., 512 ms) and plotted verses time. Plots 810-860 may be conceptually viewed as corresponding to coherograms 710-760, but with three coherence band levels instead of coherence values at numerous frequencies. As may be seen in plots 810-860, certain frequency bands (e.g., low and middle) change values at 14 seconds and 25.5 seconds (illustrated by dark vertical lines). In such a manner, the coherence of frequency bands of interest may be observed changing over time. Plots 810-860 may be used to visually or automatically observe and detect signal routing in a network, as will be explained, for example, with reference to FIG. 9.

FIG. 9 is an exemplary routing diagram 900 generated using the coherence band level plots 810-860. At any given instant in time, the coherence band levels for a pair of nodes 210 may be displayed as a number of (perhaps different colored) lines between the nodes. For example, lines 912, 914, and 916 of Coherence Band Level₁₂ correspond at any instant in time to the values of plots 812, 814, and 816, respectively. The intensity of the lines (e.g., 912-916) may be proportional to the magnitude of the corresponding coherence band levels, and the intensity of the lines may vary with time. Such a routing diagram 900 may visually show how signal routing varies among nodes in a network 500 with time. For such variances, the movement of certain nodes relative to certain other nodes, and other information, may be inferred. In other implementations, the graphical routing diagram 900 may not be generated, and detection/analysis algorithms may automatically generate analysis results from the data in FIG. 8. Those skilled in the art will appreciate how to “mine” plots 810-860, for example, for useful data about the signal flows in a network.

### Conclusion

Methods and systems consistent with the principles of the invention may use coherence information of intercepted communication data to determine traffic flow among nodes, even when the data is encrypted. Coherence information between different pairs of nodes may be used to determine data routing and routing changes within the network..

The foregoing description of preferred embodiments of the invention provides illustration and description, but is not intended to be exhaustive or to limit the invention to the precise form disclosed. Modifications and variations will be apparent to those skilled in the art in light of the above teachings or may be acquired from practice of the invention.

For example, the data processing shown in FIGS. 6-9 may be performed by a computer program or software instructions executed on a general-purpose processor (not shown). Where expeditious, some instructions may be performed in parallel on multiple processors (e.g., computing different periodograms). The computer program or software instructions may be embodied on a computer-readable medium (e.g., magnetic, optical, semiconductor, etc.) that is readable by a general-purpose processor.

Further, although cross spectral density and coherence have been discussed as one way to obtain similarity information about a pair of signals, other types of signal processing may be used that generate such similarity information. It is specifically contemplated that these other schemes for generating a diagram of signal similarity verses frequency may be utilized according to the principles of the invention described herein.

Moreover, the acts in FIG. 3 need not be implemented in the order shown; nor do all of the acts need to be performed. Also, those acts which are not dependent on other acts may be performed in parallel with the other acts.

No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the claims and their equivalents.

What is claimed is:

1. A method of analyzing communication in a network, comprising:
obtaining time of arrival information for chunks of data in the network;
constructing a plurality of signals to represent the time of arrival information at respective nodes in the network; and
processing a pair of the plurality of signals to obtain similarity information about data flow between a corresponding pair of nodes.

2. The method of claim 1, wherein the time of arrival information includes at least one of a node on the network that transmitted the chunk of data, a duration of the chunk of data, and a node on the network that will receive the chunk of data.

3. The method of claim 1, wherein the network is a wireless network.

4. The method of claim 1, wherein the network is a wired network.

5. The method of claim 1, wherein the constructing includes:
encoding times of arrival as impulses or pulses using uniform sampling of the time of arrival information.

6. The method of claim 1, wherein the processing includes:
generating coherence values verses frequency for the pair of nodes.

7. The method of claim 6, wherein the processing includes:
generating different coherence values for different pairs of nodes in the network.

8. The method of claim 1, wherein the processing includes:
generating cross spectral density values verses frequency for the pair of nodes.

9. The method of claim 8, wherein the processing includes:
generating different cross spectral density values for different pairs of nodes in the network.

10. The method of claim 1, wherein the processing includes:
generating a coherogram including coherence values over a range of frequencies verses time for the pair of nodes.

11. The method of claim 10, wherein the generating includes:
computing a plurality of coherograms from the plurality of signals, each coherogram corresponding to a different pair of nodes.

12. The method of claim 1, further comprising:
analyzing data flow between the pair of nodes using the similarity information.

13. The method of claim 7, further comprising:
analyzing data flow among the nodes in the network using the different coherence values.

14. A method of processing communication signals, comprising:
associating the signals into pairs of the signals;
computing a plurality of coherence data from the pairs of the signals;
combining the plurality of coherence data in time sequence to form a plurality of coherograms containing the coherence data; and
analyzing the plurality of coherograms to derive information about data flow.

15. The method of claim 14, wherein the computing includes:
generating each of the coherence data using a cross spectral density of the pair of signals.

16. The method of claim 15, wherein the generating includes:
obtaining a coherence of the pair of signals using the cross spectral density of the pair of signals.

17. The method of claim 14, wherein each of the coherograms corresponds to a different pair of the signals.

18. The method of claim 17, wherein the analyzing includes:
determining that the data flow has changed when a distinct change occurs in one or more of the coherograms.

19. A method of processing a plurality of communication signals obtained from a respective plurality of different nodes in a network, comprising:
computing a plurality of coherence data from different pairs of the signals;
generating a plurality of coherence band values for at least two frequency bands within the coherence data; and
combining the plurality of coherence band values in time sequence to form a plurality of coherence band level data.

20. The method of claim 19, wherein each coherence band level data corresponds to a different pair of nodes in the network.

21. The method of claim 19, further comprising:
analyzing the plurality of coherence band level data to derive information about data flow among the different nodes in the network.

22. The method of claim 21, wherein the information about data flow includes information about how data traffic in the at least two frequency bands is routed among the nodes in the network.

23. A computer-readable medium that stores instructions executable by one or more processors to perform a method for processing a signal, comprising:
instructions for computing a plurality of coherence data from different pairs of the signals;
instructions for combining the plurality of coherence data in time sequence to form a plurality of coherograms containing the coherence data; and
instructions for analyzing the plurality of coherograms to derive information about data flow.

24. The computer-readable medium of claim 23, wherein the instructions for analyzing include:
instructions for determining that the data flow has changed when a distinct change occurs in one or more of the coherograms.

25. A communication tap in a network, comprising:
means for obtaining time of arrival information for chunks of data in the network;
means for constructing a plurality of signals to represent the time of arrival information at respective nodes in the network; and
means for processing a pair of the plurality of signals to obtain cross spectral density or coherence information about data flow between a corresponding pair of nodes.

26. The communication tap of claim 25, further comprising:
means for analyzing data flow between the pair of nodes using the similarity information.

27. A method of processing communication signals, comprising:
associating the signals into pairs of the signals;
computing a plurality of cross spectral density data from the pairs of the signals;
combining the plurality of cross spectral density data in time sequence to form a plurality of data structures containing the cross spectral density data; and
analyzing the plurality of data structures to derive information about data flow.
